(19) United States
(12) Patent Application Publication
(10) Pub. No.: US 2003/0064699 A1
(43) Pub. Date: Apr. 3, 2003

(54) Down-converting multiple received radio frequency signals

(76) Inventor: Gordon A. Olsen, Tigard, OR (US)

Correspondence Address: FISH & RICHARDSON P.C., 3300 DAIN RASCHER PLAZA, 60 SOUTH SIXTH STREET, MINNEAPOLIS, MN, 55402, US

(21) Appl. No.: 09/967,490

(22) Filed: Sep. 28, 2001

(51) Int. Cl. H04B 1/26

(52) U.S. Cl. 455/318; 455/313; 455/323

(57) ABSTRACT

A down-converting circuit for a multiple-band wireless communications device needs only one voltage-controlled (VCO) with a relatively narrow tuning range, and down-converts multiple different received RF signals to produce intermediate frequency (IF) signals having a common frequency. The VCO output signal serves as a first LO signal. The circuit also has up to two frequency translators, the first of which (e.g., a divide-by-2 translator) receives the VCO output signal and produces a second LO signal. The second frequency translator (e.g., a divide-by-1.5 frequency translator) also receives the VCO output signal and produces a third LO signal. The received RF signals are down-converted using the LO signals and mixers. One of the received RF signal types is a GPS signal, which is down-converted using an LO produced at the output of a divide-by-1.5 frequency translator.

### TECHNICAL FIELD

The invention relates to wireless communications, and more particularly, to down-converting received radio frequency (RF) signals to intermediate frequency (IF) signals.

### BACKGROUND

Typically, wireless communications devices, such as mobile telephones and the like, support multiple communication services that operate within different frequency bands. In the United States for example, cellular systems operate within a frequency band of about 869 to 894 megahertz (MHz), whereas Personal Communication Service (PCS) systems operate within a frequency band of about 1930 to 1990 MHz. Mobile wireless devices are typically capable of using both cellular and PCS services (and are thus termed “dual-band” devices), because in some geographic locations, only PCS service may be available, or vice versa.

The Global Positioning System (GPS) is a widely used satellite navigation system. GPS signals from the GPS satellites are transmitted at 1575.42 MHz. GPS receivers have begun to be incorporated into wireless communications devices. In fact, the United States Federal Communications Commission has mandated that by October 2001 wireless service providers must have a way to determine the location of a caller. Location of a caller may be critical, for example, in the case of an emergency “911” call. Having a GPS receiver within the wireless communications device gives the device the capability of receiving transmissions from the GPS satellites, from which the location of the device can be determined. The wireless communications device may in turn transmit the determined location information, for example, in connection with a “911” call.

When an RF signal is received, be it a cellular signal, a PCS signal, or a GPS signal, for example, the signal is typically “down-converted” to a lower carrier frequency for processing. The down-conversion is typically done using a mixer and a local oscillator (LO) signal whose frequency is established by a voltage-controlled oscillator (VCO). The mixer receives both the received RF signal and the LO signal, and produces a signal having the same information as was contained in the received RF signal, but operating on a carrier frequency equal to the difference between the frequency of the received RF signal and the frequency of the LO signal.

The down-converted lower carrier frequency is referred to as an “intermediate frequency” (IF). Different IF frequencies are used in different commercial systems. By way of example, a typical IF signal frequency may be anywhere from about 50 to 250 MHz. For multiple-band devices, it is preferable to down-convert all of the received RF signals to a common IF. This reduces filtering requirements for IF signals. Having a common IF for multiple band-devices drives the design of the down-converter. Some prior art designs have used a separate VCO for each band to produce the LO signal needed to produce an IF signal with the specified common IF carrier frequency. Recently, a single VCO has been used to produce two different LO signals, one for down-converting received cellular signals to an IF signal, and one for down-converting PCS signals to an IF signal of the same frequency as the cellular IF frequency. However, having three or more bands in a device and still achieving a common IF frequency is a significantly more difficult design challenge.

What is needed are designs for down-converting in multiple band devices that minimize the cost and complexity of the design.

### SUMMARY

The invention provides, for multiple-band wireless communications devices, designs for down-converting circuits that require only one voltage-controlled (VCO) having a relatively narrow tuning range, and that down-convert different types of received RF signals operating in multiple frequency ranges, or bands, to IF signals having a common frequency.

In one aspect, the invention provides a circuit that produces at least three LO signals for down-converting at least three different RF signals operating within three different frequency ranges, or bands. This circuit includes a single VCO that produces an output signal that serves as a first LO signal. The circuit also has two frequency translators, the first of which receives the VCO output signal and produces a second LO signal having a frequency that differs from the frequency of the first LO signal. The second of the frequency translators also receives the VCO output signal and produces a third LO signal having a frequency that differs from the frequency of both the first LO signal and the second LO signal. The single VCO may be a separate chip from the rest of the down-converting circuitry, or may be integrated with the other down-converting circuitry.

In one embodiment, three different types of RF signal may be received: (1) PCS signals operating within a range of about 1930 to 1990 MHz, (2) cellular signals operating within a range of 869 to 894 MHz, and (3) GPS signals operating at about 1575 MHz. All of the RF signals may be down-converted to a selected IF signal frequency that is common for all three RF signal types. The selected common IF signal frequency may be a specific frequency of about 180 MHz (for example, 183.6 MHz). A single VCO, in connection with two frequency translators, may be used to produce the three LO's needed to down-convert all three RF signal types to a common IF signal frequency. First, the VCO output may be used directly as the LO for down-converting PCS signals, a divide-by-2 frequency translator that receives the VCO output may be used to generate the LO for down-converting the cellular signals, and a divide-by-1.5 frequency translator that also receives the VCO output may be used to generate the LO for down-converting the GPS signals.

In this embodiment, the received PCS signals may be down-converted using a high-side mixer and the first LO signal (that is, the VCO output), the received cellular signals may be down-converted using another high-side mixer and the second LO signal at the output of the divide-by-2 frequency translator, and the received GPS signals may be down-converted using a low-side mixer and the third LO signal at the output of the divide-by-1.5 frequency translator. As such, the VCO may be tuned within a range of about 2110 to 2170 MHz (thus producing a first LO signal of the same frequency) to down-convert received PCS signals, may be tuned within a range of about 2098 to 2148 MHz (thus producing a second LO signal within the range of about 1049 to 1074 MHz) to down-convert received cellular signals, and may be tuned to a frequency of about 2092 MHz (thus producing a third LO signal having a frequency of about 1395 MHz) to down-convert received GPS signals. Thus it can be seen that to produce the three LO's that are needed in this embodiment, the VCO need only be tunable within a relatively narrow range of about 2092 to 2170 MHz. In other words, there is only a 78 MHz difference between the highest and lowest needed frequencies.

Other embodiments of the invention apply to wireless systems that use other frequency bands, such as the IMT2000 band of about 2111 to 2159 MHz used in Japan and Europe, a cellular band of about 833 to 869 used in Japan, and a PCS band of 1840 to 1870 used in Korea. The frequency of GPS signals is the same regardless of the location. In multiple-band systems (IMT2000, cellular and GPS) that are currently applicable or proposed in Japan and Europe, for example, as with the embodiments described above, a VCO output signal may serve as an LO signal for down-converting the IMT2000 band, a divide-by-3 frequency translator that receives the VCO output signal may be used to produce an LO signal for down-converting the cellular band, and a divide-by-1.5 frequency translator that also receives the VCO output signal may be used to produce an LO signal for down-converting the GPS band. As with other embodiments, mixers that receives the LO signals down-convert the received RF signals to a common IF signal frequency, which in this embodiment, may be a specifically selected frequency of about 110 MHz. In this embodiment, in order to produce the multiple LO signals to down-convert all received RF signal types to the selected common IF signal frequency, the VCO need only be tunable within a relatively narrow range from about 2167 to about 2277 MHz.

In another embodiment applicable to the Korean market using a band of 1840 to 1870 MHz for PCS signals, a dual-channel communications device for PCS and GPS signals uses a common IF signal frequency of about 210 MHz, or alternatively, about 220 MHz. In this embodiment, a single VCO again produces the LO signals for both channels, with the VCO output serving as the LO for the PCS channel, and the output of a divide-by-1.5 frequency translator serving as the LO for the GPS band. In the embodiment using the 210 MHz common IF signal frequency, the VCO need only be tunable within a relatively narrow range of about 2048 MHz to about 2080 MHz.

In another aspect, the invention provides a circuit that produces, in a wireless communications device, an LO signal for down-converting a GPS signal. Importantly, the circuit includes a divide-by-1.5 frequency translator. This frequency translator may be used to produce an LO signal used to down-convert a GPS signal to an IF signal selected to be any frequency in the range of about 100 MHz to about 230 MHz. In different embodiments, the IF signal frequency is about 180 MHz, about 110 MHz, about 210, and about 220. It will be recognized, however, that this is not an exhaustive list of IF signal frequencies that may be selected. In the case where the IF signal frequency is 180 MHz, the LO signal may be about 1395 MHz, for example, in which case a low-side mixer may be used to down-convert received GPS signals using the 1395 MHz LO signal. In another aspect, the invention provides a circuit that produces at least two LO signals using a single VCO for down-converting a GPS signal and at least one other RF signal type. This circuit includes the single VCO that produces a VCO output signal that serves as the LO for down converting a non-GPS RF signal. The circuit also includes a divide-by-1.5 frequency translator that receives the VCO signal and produces a second LO signal for down-converting the GPS signal. The non-GPS RF signals may be a PCS signal operating within a range of about 1930 to 1990 MHz, or an IMT2000 signal operating within a range of about 2111-2159 MHz, to name just two examples.

A divide-by-1.5 frequency translator used in connection with embodiments of the invention may have different designs. For example, the divide-by-1.5 frequency translator may include a low-side mixer that receives the VCO output signal and a feedback signal to produce the third LO signal. A divide-by-two frequency translator receives the third LO signal and produces the feedback signal received by the low-side mixer. Alternatively, the divide-by-1.5 frequency translator may include a cascade of a frequency doubler followed by a divide-by-3 frequency translator, or a cascade of the divide-by-3 frequency translator followed by the frequency doubler.

The invention offers the following advantages. The invention achieves a common IF signal frequency for different received RF signal bands while minimizing the tuning range of a single VCO used in the design. As such, a less expensive, smaller, and perhaps better performing VCO may be used. This realizes wireless communications devices that are smaller and lighter in weight, and that incorporate additional capability such as being able to receive GPS RF signals for location determination.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of a circuit in accordance with an embodiment of the invention.

FIG. 2 is a chart showing example signal frequencies that relate to the circuit of FIG. 1.

FIG. 3 is a block diagram of an embodiment of a divide-by-1.5 frequency translator that may be used in the circuit of FIG. 1.

FIG. 4 is a block diagram of an alternative embodiment of a divide-by-1.5 frequency translator that may be used in the circuit of FIG. 1.

FIG. 5 is a block diagram of a further alternative embodiment of a divide-by-1.5 frequency translator that may be used in the circuit of FIG. 1.

Like reference symbols in the various drawings indicate like elements.

### DETAILED DESCRIPTION

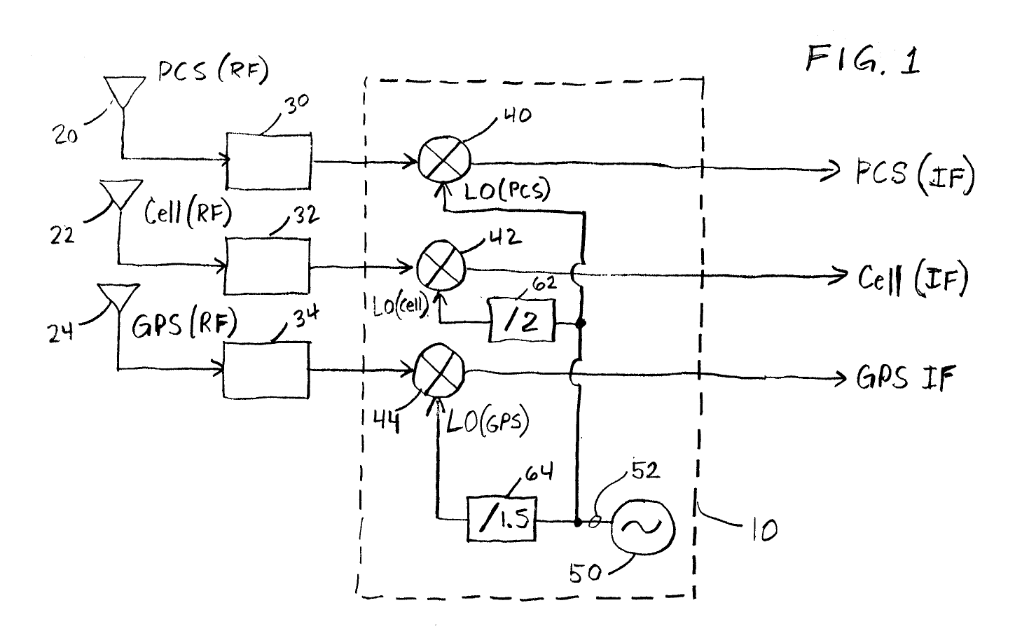

In FIG. 1, a frequency down-converter 10 in accordance with the invention receives three different RF signals operating within different RF bands and down-converts them to three IF signals operating at a common frequency. The frequency down-converter 10 may be used in a wireless communications device. In this embodiment, the common IF signal frequency is selected to be a specific frequency that may be about 180 MHz. For example, an IF signal frequency of 183.6 MHz is commonly selected for various reasons, including the availability of filters that receive the IF signal which are adapted for that frequency, and because this frequency avoids spurious responses that result from other IF signal frequency choices. As will be appreciated, however, the invention applies to systems that use other selected IF signal frequencies.

The down-converter 10 in the FIG. 1 embodiment is applicable to the U.S. wireless market. For example, in one embodiment, the three received RF signals are, firstly, a PCS signal PCS(RF) operating within the range of 1930 to 1990 MHz, which is received at antenna 20. The second received RF signal is a cellular signal Cell(RF), for example, a signal specified by the Advanced Mobile Phone Service (AMPS) standard, operating within the range of about 869 to 894 MHz. The cellular signal Cell(RF) is received at antenna 22. The third RF signal, received at antenna 24, is a GPS signal GPS(RF) operating at about 1575 MHz (1575.42 MHz to be exact). Although in FIG. 1, the three RF signals are shown as being received at three separate antennas 20, 22 and 24, it will be understood that a common antenna or antennas may be used.

As is known among persons skilled in the art, within the PCS band and the cellular band, there are several channels across the bands. For example, in code-division multiple access (CDMA) systems, which use the PCS or cellular bands, each channel is 1.25 MHz wide, and for systems using the AMPS standard, the channel width is about 30 KHz. Also, the PCS band covers 1930 to 1990 MHz on downlink transmissions (that is, base station to the wireless communications device), and the associated uplink channel is 80 MHz below the downlink channel. The cellular band covers 869 to 894 MHz on the downlink, and the uplink channel is 45 MHz below the downlink channel. Conventionally for each of these bands, there is a “pilot” channel which the wireless communications device initially uses to communicate with a base station to obtain instructions from the base station about the channel on which to operate.

The three received RF signals—PCS(RF), Cell(RF) and GPS(RF)—are respectively pre-processed by conventional front-end circuitry 30, 32 and 34 to filter and amplify the signals, for example. The output of front-end circuitry 30, 32 and 34 are pre-processed signals operating at the same frequency as the RF signals as received at the antennas 20, 22 and 24.

The down-converter 10 includes three mixers 40, 42 and 44, one for each of the three channels of PCS, cellular and GPS. The down-converter 10 also includes a single voltage controlled oscillator (VCO) 50. The VCO 50 produces an oscillating signal whose frequency is determined by an input voltage (not shown in FIG. 1). The VCO 50 may be part of the same down-converter chip as the mixers 40, 42 and 40. Alternatively, the VCO 50 may reside on a separate chip or module, as is commonly the case.

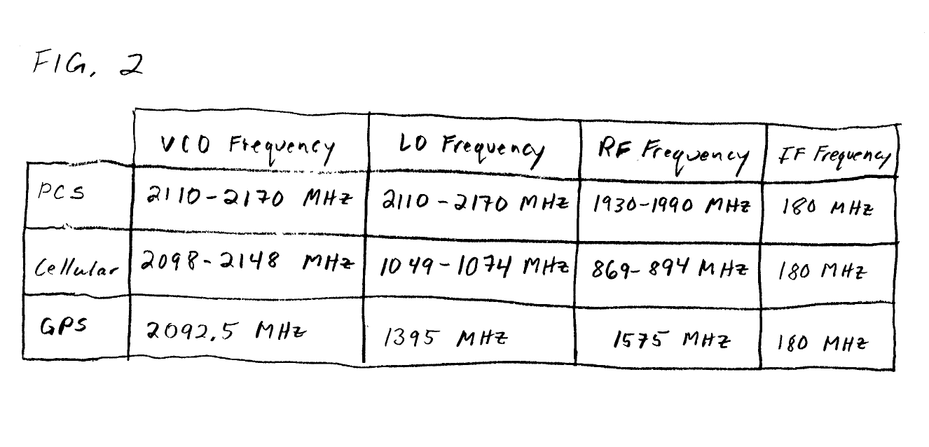

The VCO 50 is the source for three LO signals having three different frequencies—the LO signal for the PCS channel, LO(PCS), the LO signal for the cellular channel, LO(Cell), and the LO signal for the GPS channel, LO(GPS). In one embodiment, when a PCS RF signal is being received, the VCO 50 produces an output oscillating signal 52 having a frequency falling within the range of 2110 to 2170 MHz. The VCO 50 receives a voltage (not shown in FIG. 1) at a level necessary to produce signal 52 having such a frequency. The output oscillating signal 52 is received directly at mixer 40; therefore, VCO signal 52 serves as the PCS LO signal LO(PCS). Mixer 40, in this embodiment, is of a conventional high-side type of mixer, which produces a down-converted signal whose frequency is equal to the LO signal frequency minus the frequency of the signal to be down-converted. In other words, the frequency of the LO signal is higher than the frequency of the signal to be down-converted. The mixer 40 thus produces an IF signal, PCS(IF), whose frequency is about 180 MHz. For example, 2170 MHz minus 1990 MHz equals 180 MHz, and 2110 MHz minus 1930 MHz equals 180 MHz. FIG. 2 shows a compilation of these frequencies.

The specific frequency of oscillating signal 52 within the range of 2110 to 2170 MHz needed to produce an IF signal having the specified IF signal frequency will depend on which downlink channel within the PCS band is being used. For example, if the downlink channel being used is 1945 MHz, the voltage controlling the VCO 50 will be set to achieve an oscillating signal 52 of about 2125 MHz to produce an IF signal with a frequency of about 180 MHz. Also, the specified frequency and tolerance of the IF signal will affect the needed frequency and tolerance of the oscillating signal 52.

When a cellular RF signal is being received, the VCO 50 produces an output oscillating signal 52 having a frequency falling within the range of 2098 to 2148 MHz. The VCO 50 receives a voltage (not shown in FIG. 1) at a level necessary to produce signal 52 having such a frequency. As is convention in a dual-band PCS and cellular system, the output oscillating signal 52 is received at a divide-by-two frequency translator 62, which produces a cellular LO signal LO(Cell) falling within the range of 1049 to 1074 MHz. Mixer 42, in this embodiment, is a high-side mixer, and so the mixer 42 produces an IF signal, Cell(IF), whose frequency is also about 180 MHz. For example, 1074 MHz minus 894 MHz equals 180 MHz, and 1049 MHz minus 869 MHz equals 180 MHz. Again, these frequencies are tabulated in FIG. 2. In addition, as with the PCS band, the specific frequency of oscillating signal 52 needed to produce an IF signal having the specified IF signal frequency will depend on which downlink channel within the cellular band that is being used, as well as the specified frequency and tolerance of the IF signal.

Finally, when a GPS RF signal is being received, the VCO 50 produces an output oscillating signal 52 having a frequency of about 2092.5 MHz, as tabulated in FIG. 2. The VCO 50 receives a voltage (not shown in FIG. 1) at a level necessary to produce signal 52 having such a frequency. The output oscillating signal 52 is received, in accordance with the invention, at a divide-by-one-and-a-half frequency translator 64, which produces a GPS LO signal LO(GPS) having a frequency of about 1395 MHz. Mixer 44, in this embodiment, is a low-side mixer, and so the mixer 44 produces an IF signal, GPS(IF), whose frequency is also about 180 MHz. For example, 1575 MHz minus 1395 MHz equals 180 MHz.

In cellular and PCS operation the VCO 50 will be tuned to a specific frequency within the range described above, such that the received RF signal is converted to about 180 MHz for further processing. This IF signal is typically passed through a filter having a bandwidth that is sufficiently narrow to pass only a single channel (the desired channel). For GPS operation, there is only a single frequency of interest (about 1575 MHz), so the VCO 50 will be tuned to convert only that frequency to an IF signal having a frequency of about 180 MHz.

Therefore, in the FIG. 1 circuit 10, the VCO 50 only needs to be capable of being tuned within a relatively narrow range—2092.5 MHz to 2170 MHz. In other words, there is only a 78 MHz difference between the highest and lowest needed frequencies. A VCO tunable in such a narrow range is typically referred to as a single-band VCO. As persons skilled in the art will understand, a VCO tunable in this relatively narrow range (that is, a single-band VCO) is practically and economically realizable for wireless communications devices. By way of example, such a VCO, when in the form of a separate module, presently consumes on the order of about 5×5 millimeter of board space, and will be relatively inexpensive.

The use of one single-band VCO with the invention is advantageous compared to alternative designs. For example, it is theoretically possible to use a single VCO that tunes from 1049 to 2170 MHz. However, such a VCO is not practical for mobile wireless communications devices because the VCO will produce too much phase noise and requires precise optimization of the VCO. In addition, improvements in phase noise require the use of larger, more expensive resonators and more current in the VCO. For example, using a yittrium/iron/garnet (YIG) resonator, a VCO can be realized that is tunable over a very large frequency range (for example, 2 GHz to 8 GHz), but this type of VCO is presently very expensive and large. Also, a varactor-based VCO can be designed to tune an octave, but only if the full tuning range of the varactor is used, which requires a 4:1 capacitance change in the varactor. This tuning sensitivity degrades the phase noise performance. Other broadband VCO's, referred to as “dual-band” or “multi-band” VCO's, use a combination of a varactor and switched capacitors, or may consist of two VCO's in a single VCO package. Compared to a single band VCO, a dual-band VCO is larger, more expensive, and in some cases, have lower performance.

As mentioned previously, the VCO 50 may reside on a separate chip or module, as is commonly the case. Similarly, one or both of the frequency translators 62 and 64 need not be on the same chip as mixers 42 and 44, and again may be on a separate chip from the VCO 50. For example, the divide-by-1.5 frequency translator 64 may be provided with a chip that provides GPS capability and which is intended to be integrated with other circuitry in a wireless communications device to provide for multiple bands (including at least a GPS band). In yet another embodiment, the wireless communications device is a dual-band device, one band being GPS. The non-GPS band may be the PCS band, for example. In this embodiment, because the wireless communications device does not also have a cellular band, the divide-by-2 frequency translator 62 and mixer 42 would not be needed.

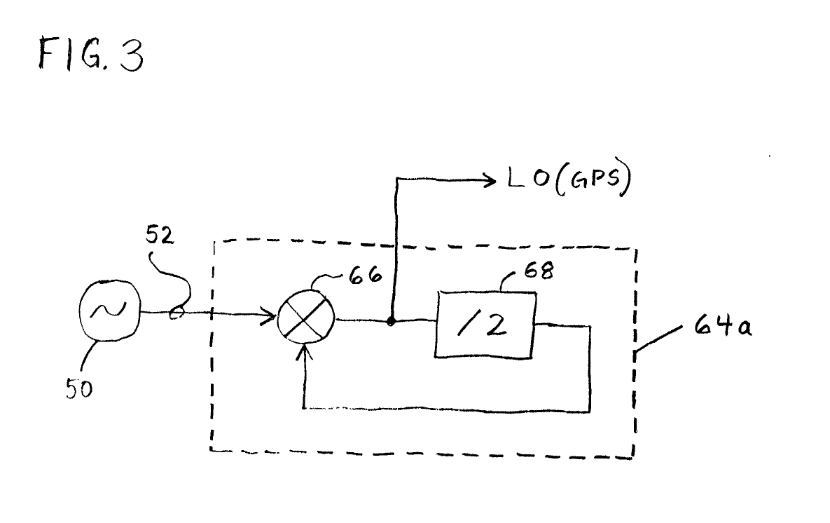

Referring to FIG. 3, an embodiment of a divide-by-1.5 frequency translator 64a, which may be used as the translator 64 in FIG. 1, includes a low-side mixer 66 that receives the VCO signal 52. The divide-by-1.5 frequency translator 64a also includes a feedback loop having a divide-by-2 frequency translator 68. The output of the mixer 66 is received at an input of the divide-by-2 frequency translator 68, which produces an output signal which is fed back as an LO signal to the low-side mixer 66. The low-side mixer 66 thus produces the signal LO(GPS) with a frequency that is two-thirds the frequency of the VCO signal 52. For example, assuming the frequency of VCO signal 52 is 2092.5 MHz, as mentioned above, then, after an initial period of time to allow the operation of the divide-by-1.5 frequency translator 64a to become stable, the output of the divide-by-2 frequency translator 68, which output is fed back to the mixer 66, is a signal oscillating at a frequency of 697.5 MHz. The low-side mixer thus produces an output, LO(GPS), which is a signal oscillating at a frequency of 1395 MHz (that is, 2092.5 MHz minus 697.5 MHz). The signal LO(GPS) is received at the divide-by-2 frequency translator 68, thus producing the signal oscillating at a frequency of 697.5 MHz received at mixer 66.

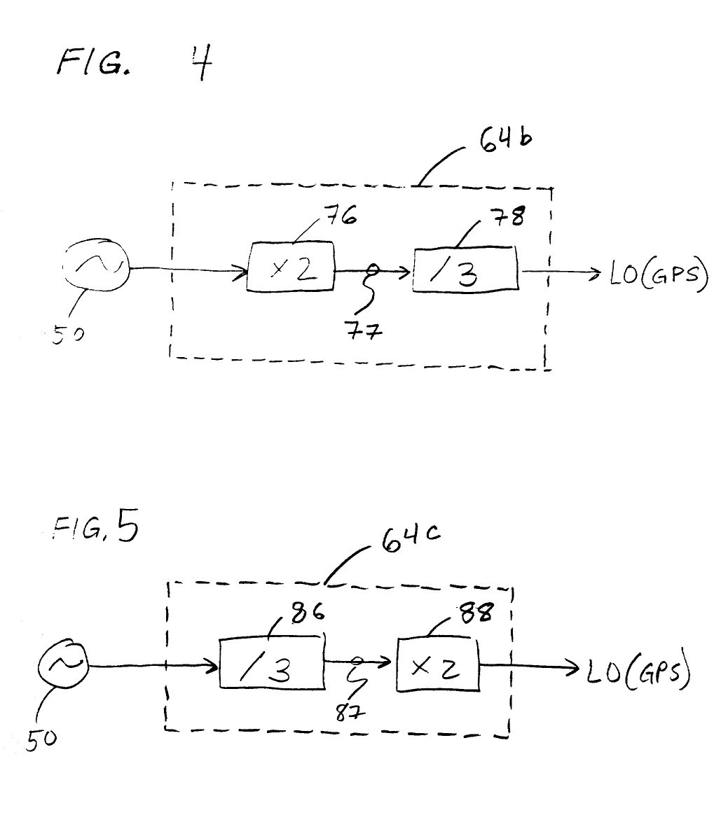

In FIG. 4, an alternative embodiment of a divide-by-1.5 frequency translator 64b is a cascade of a multiply-by-2 frequency translator 76 followed by a divide-by-3 frequency translator 78. Compared to translator 64a shown in FIG. 3, translator 64b shown in FIG. 4, because of its front-end multiply-by-2 frequency translator 76, creates an intermediate signal on line 77 having a relatively high frequency, namely, 4184 MHz. This high intermediate-signal frequency is a significant consumer of current, which in some cases will not be acceptable in the design. In other cases, however, the relatively high current consumption of translator 64b may be tolerable. A further trade-off with the divide-by-1.5 frequency translator 64b shown in FIG. 4, compared to the translator 64a shown in FIG. 3, is that a divide-by-3 frequency translator 78 is not easily implemented, and also creates unwanted image frequencies.

In FIG. 5, a further alternative embodiment of a divide-by-1.5 frequency translator 64c is a cascade of a divide-by-3 frequency translator 86 followed by a multiply-by-2 frequency translator 88. Divide-by-1.5 frequency translator 64c also has drawbacks compared to the frequency translator 64a shown in FIG. 3. Namely, translator 64c includes the divide-by-3 frequency translator 78, and thus has the drawbacks discussed previously in connection with the frequency translator 64b shown in FIG. 4. However, the FIG. 5 translator 64c has the advantage, compared to the translator 64b shown in FIG. 4, of producing an intermediate signal, on line 87, that is of a much lower frequency, namely, 697.5 MHz, and thus does not have the current consumption drawbacks that translator 64b has.

Throughout this specification, reference has been made to various types of frequency translators—for example, divide-by-2, divide-by-3, and multiply-by-2. It will be understood that the design of such frequency translators, beyond the details disclosed herein, for example, in connection with the divide-by-1.5 frequency translators, is within the level of skill in the art. For example, a divide-by-2 frequency translator may simply be a flip-flop. Also, a divide-by-3 frequency translator, for example, may be made up of two flip-flops, where one is resetting the other.

It will further be appreciated that the use of a divide-by-1.5 frequency translator to produce an LO for down-converting GPS signals has applicability to other multi-band wireless communication devices that include a GPS band, and has applicability across a range of selected common IF signal frequencies. For example, in one embodiment that may be applicable in the Japanese market, a multiple-band wireless communications device may include three types of RF signals: IMT2000 signals operating in a band of about 2111 to 2159 MHz, cellular signals operating in a band of about 833 to 869 MHz, and GPS signals operating at 1575.42 MHz. A common IF signal frequency of 110 MHz may be selected. In this embodiment, the system will look similar to the system shown in FIG. 1, except that the PCS band noted in FIG. 1 would be the IMT2000 band, and the divide-by-2 frequency translator 62 would be a divide-by-3 frequency translator. Using a single VCO to produce three LO's needed to down-convert all three signal types to IF signals of 110 MHz, the output of the VCO 50 may be used to produce the LO for down-converting the IMT2000 signals, a divide-by-3 frequency translator that receives the VCO output may be used to produce the LO for down-converting the cellular signals, and the divide-by-1.5 frequency translator 64 that also receives the VCO output may be used to produce the LO for down-converting the GPS signals.

The received IMT2000 signals may be down-converted using a high-side mixer 40 and the first LO signal (that is, the VCO output), the received cellular signals may be down-converted using a low-side mixer 42 and the second LO signal at the output of the divide-by-3 frequency translator, and the received GPS signals may be down-converted using another low-side mixer 44 and the third LO signal at the output of the divide-by-1.5 frequency translator. As such, the VCO may be tuned within a range of about 2221 to 2269 MHz (thus producing a first LO signal of the same frequency) to down-convert received IMT2000 signals, may be tuned within a range of about 2169 to 2277 MHz (thus producing a second LO signal within the range of about 723 to 759 MHz) to down-convert received cellular signals, and may be tuned to a frequency of about 2198 MHz (thus producing a third LO signal having a frequency of about 1465.5 MHz) to down-convert received GPS signals. Thus, to produce the three LO's needed in this embodiment, the VCO need only be tunable within a relatively narrow range of about 2167 to 2277 MHz (that is, a 110 MHz difference between the highest and lowest needed frequencies).

Another embodiment may be applicable to the Korean market. This device may be a dual-band device able to receive PCS signals operating within a band of 1840 to 1870 MHz and GPS signals. A common IF signal frequency of 210 MHz may be selected, for example. In this embodiment, the system will look similar to the system shown in FIG. 1, except without the cellular band circuitry 32, 42 and 62. Using a single VCO to produce two LO's needed to down-convert both signal types to IF signals of 210 MHz, the output of the VCO 50 may be used to produce the LO for down-converting the PCS signals, and the divide-by-1.5 frequency translator 64 that receives the VCO output may be used to produce the LO for down-converting the GPS signals. The received PCS signals again may be down-converted using the high-side mixer 40 and the first LO signal (that is, the VCO output), and the received GPS signals may be down-converted using the low-side mixer 44 and the third LO signal at the output of the divide-by-1.5 frequency translator. As such, the VCO may be tuned within a range of about 2050 to 2080 MHz (thus producing a first LO signal of the same frequency) to down-convert received PCS signals, and may be tuned to a frequency of about 2048 MHz (thus producing a GPS LO signal having a frequency of about 1365.5 MHz) to down-convert received GPS signals. Thus, to produce the two LO's needed in this embodiment, the VCO need only be tunable within a relatively narrow range of about 2048 to 2080 MHz (that is, 32 MHz between the lowest and highest needed frequencies). Also, because 220 MHz is a commonly used common IF signal frequency used in the Korean market, it will be understood that minor adjustments to the above-described frequencies may be made if a common IF signal frequency of 220 MHz is selected.

A number of embodiments of the invention have been described. Nevertheless, it will be understood that various modifications may be made without departing from the spirit and scope of the invention. For example, the invention may be used in systems where different frequency bands are used, such as in countries other than the United States, and in systems where a different common IF signal frequency is used. Accordingly, other embodiments are within the scope of the following claims.

What is claimed is:

1. A circuit for producing a plurality of LO signals for down-converting a plurality of different RF signals operating in different frequency ranges, the circuit comprising:
a VCO that produces a VCO output signal that serves as a first LO signal having a first frequency;
a first frequency translator that receives the VCO output signal and produces a second LO signal having a second frequency that differs from the first frequency; and
a second frequency translator that receives the VCO output signal and produces a third LO signal having a third frequency that differs from both the first frequency and the second frequency.

2. The circuit of claim 1, wherein the plurality of different RF signals operating in different frequency ranges are down-converted to IF signals having a common frequency.

3. The circuit of claim 2, wherein the common IF signal frequency is a frequency selected within a range from 100 MHz to 230 MHz.

4. The circuit of claim 2, wherein the VCO has a tuning range of not more than 120 MHz.

5. The circuit of claim 4, wherein the VCO has a tuning range of not more than 80 MHz.

6. The circuit of claim 3, wherein the common IF signal frequency is selected to be a frequency of about 180 MHz.

7. The circuit of claim 6, wherein the common IF signal frequency is selected to be 183.6 MHz.

8. The circuit of claim 6, wherein the VCO has a tuning range of not more than 80 MHz.

9. The circuit of claim 1, wherein the plurality of different RF signals comprise:
a first signal operating within a range of about 1930 to 1990 MHz, the first signal being down-converted using a first mixer and the first LO signal;
a second signal operating within a range of about 869 to 894 MHz, the second signal being down-converted using a second mixer and the second LO signal; and
a third signal operating at about 1575 MHz, the third signal being down-converted using a third mixer and the third LO signal.

10. The circuit of claim 9, wherein the plurality of different RF signals are down-converted to IF signals all having a frequency of about 180 MHz.

11. The circuit of claim 10, wherein the first frequency translator is a divide-by-2 frequency translator, and the second frequency translator is a divide-by-1.5 frequency translator.

12. The circuit of claim 11, wherein the VCO is capable of producing a VCO output signal with a frequency tunable within the range of about 2092 MHz to about 2170 MHz.

13. The circuit of claim 11, wherein, during down-conversion of the first RF signal, the VCO produces a VCO output signal having a frequency within the range of about 2110 MHz to 2170 MHz, thus producing a first LO signal having a frequency within the range of about 2110 MHz to 2170 MHz.

14. The circuit of claim 13, wherein, during down-conversion of the second RF signal, the VCO produces a VCO output signal having a frequency within a range of about 2098 MHz to 2148 MHz, thus producing a second LO signal having a frequency within the range of about 1049 MHz to 1074 MHz.

15. The circuit of claim 14, wherein, during down-conversion of the third RF signal, the VCO produces a VCO output signal having a frequency of about 2092 MHz, thus producing a third LO signal having a frequency of about 1395 MHz.

16. The circuit of claim 11, wherein the divide-by-1.5 frequency translator comprises:
a low-side mixer that receives the VCO output signal and a feedback signal to produce the third LO signal; and
a divide-by-2 frequency translator that receives the third LO signal and produces the feedback signal received at the low-side mixer.

17. The circuit of claim 11, wherein the divide-by-1.5 frequency translator comprises:
a divide-by-3 frequency translator that receives the VCO output signal and produces an intermediate signal; and
a multiply-by-2 frequency translator that receives the intermediate signal and produces the third LO signal.

18. The circuit of claim 11, wherein the divide-by-1.5 frequency translator comprises:
a multiply-by-2 frequency translator that receives the VCO output signal and produces an intermediate signal; and
a divide-by-three frequency translator that receives the intermediate signal and produces the third LO signal.

19. A circuit for receiving a VCO output signal having a VCO frequency and using the VCO output signal for down-converting a plurality of different RF signals operating in different frequency ranges, the circuit comprising:
a first mixer that receives a first RF signal, receives the VCO output signal as a first LO signal, and produces a first IF signal;
a first frequency translator that receives the VCO output signal and produces a second LO signal having a second frequency that differs from the first frequency;
a second mixer that receives a second RF signal and the second LO signal and produces a second IF signal;
a second frequency translator that receives the VCO output signal and produces a third LO signal having a third frequency that differs from the first frequency and from the second frequency; and
a third mixer that receives a third RF signal and the third LO signal and produces a third IF signal.

20. The circuit of claim 19, wherein:
the first RF signal operates within a range of about 1930 to 1990 MHz;
the second RF signal operates within a range of about 869 to 894 MHz; and
the third RF signal operates at about 1575 MHz.

21. The circuit of claim 20, wherein the first IF signal, second IF signal, and third IF signal all have a frequency of about 180 MHz.

22. The circuit of claim 21, wherein:
the first mixer is a high-side mixer;
the first frequency translator is a divide-by-2 frequency translator;
the second mixer is a high-side mixer;
the second frequency translator is a divide-by-1.5 frequency translator; and
the third mixer is a low-side mixer.

23. The circuit of claim 23, wherein the VCO is capable of producing a VCO output signal with a frequency tunable within the range of about 2092 MHz to about 2170 MHz.

24. The circuit of claim 22, wherein, during down-conversion of the first RF signal, the VCO produces a VCO output signal having a frequency within the range of about 2110 MHz to 2170 MHz, thus producing a first LO signal having a frequency within the range of about 2110 MHz to 2170 MHz.

25. The circuit of claim 22, wherein, during down-conversion of the second RF signal, the VCO produces a VCO output signal having a frequency within a range of about 2098 MHz to 2148 MHz, thus producing a second LO signal having a frequency within the range of about 1049 MHz to 1074 MHz.

26. The circuit of claim 22, wherein, during down-conversion of the third RF signal, the VCO produces a VCO output signal having a frequency of about 2092 MHz, thus producing a third LO signal having a frequency of about 1395 MHz.

27. The circuit of claim 22, wherein the divide-by-1.5 frequency translator comprises:
a low-side mixer that receives the VCO output signal and a feedback signal to produce the third LO signal; and
a divide-by-2 frequency translator that receives the third LO signal and produces the feedback signal received at the low-side mixer.

28. A circuit for receiving a VCO output signal having a VCO frequency tunable within a range of about 2092 MHz to 2170 MHz and using the VCO output signal for down-converting a plurality of different RF signals operating in different frequency ranges, the circuit comprising:
a first high-side mixer that receives a first RF signal having a frequency within a range of about 1930 to 1990 MHz, receives the VCO output signal as a first LO signal, and produces a first IF signal with a frequency of about 180 MHz;
a divide-by-2 frequency translator that receives the VCO output signal and produces a second LO signal having a second frequency that equals the frequency of the VCO signal divided by two;
a second high-side mixer that receives a second RF signal having a frequency within a range of about 869 MHz to 894 MHz, receives the second LO signal, and produces a second IF signal having a frequency of about 180 MHz;
a divide-by-1.5 frequency translator that receives the VCO output signal and produces a third LO signal having a third frequency that equals the frequency of the VCO signal divided by 1.5; and
a low-side mixer that receives a third RF signal having a frequency of about 1575 MHz, receives the third LO signal, and produces a third IF signal having a frequency of about 180 MHz.

29. The circuit of claim 28, wherein the first RF signal is a PCS signal, the second RF signal is a cellular signal, and the third RF signal is a GPS signal.

30. The circuit of claim 28, wherein the divide-by-1.5 frequency translator comprises:
a low-side mixer that receives the VCO output signal and a feedback signal to produce the third LO signal; and
a divide-by-2 frequency translator that receives the third LO signal and produces the feedback signal received at the low-side mixer.

31. The circuit of claim 28, wherein the divide-by-1.5 frequency translator comprises:
a divide-by-3 frequency translator that receives the VCO output signal and produces an intermediate signal; and
a multiply-by-2 frequency translator that receives the intermediate signal and produces the third LO signal.

32. The circuit of claim 28, wherein the divide-by-1.5 frequency translator comprises:
a multiply-by-2 frequency translator that receives the VCO output signal and produces an intermediate signal; and
a divide-by-three frequency translator that receives the intermediate signal and produces the third LO signal.

33. A circuit for producing, in a wireless communications device, an LO signal for down-converting a GPS signal operating at about 1575 MHz to an IF signal, the circuit comprising:
a divide-by-1.5 frequency translator that receives a VCO output signal and produces the LO signal for down-converting the GPS signal to an IF signal.

34. The circuit of claim 33, wherein the IF signal frequency is a frequency selected within a range from 100 MHz to 230 MHz.

35. The circuit of claim 34, wherein the VCO has a tuning range of not more than 120 MHz.

36. The circuit of claim 34, wherein the VCO has a tuning range of not more than 80 MHz.

37. The circuit of claim 33, wherein the IF signal frequency is selected to be a frequency of about 180 MHz.

38. The circuit of claim 37, wherein the common IF signal frequency is selected to be 183.6 MHz.

39. The circuit of claim 37, wherein the VCO has a tuning range of not more than 80 MHz.

40. The circuit of claim 33, wherein the GPS signal is down-converted to an IF signal having a frequency of about 180 MHz and the LO signal has a frequency of about 1395 MHz.

41. The circuit of claim 33, wherein the divide-by-1.5 frequency translator comprises:
a low-side mixer that receives the VCO output signal and a feedback signal to produce the LO signal; and
a divide-by-2 frequency translator that receives the LO signal and produces the feedback signal received at the low-side mixer.

42. The circuit of claim 33, wherein the divide-by-1.5 frequency translator comprises:
a divide-by-3 frequency translator that receives the VCO output signal and produces an intermediate signal; and
a multiply-by-2 frequency translator that receives the intermediate signal and produces the LO signal.

43. The circuit of claim 33, wherein the divide-by-1.5 frequency translator comprises:
a multiply-by-2 frequency translator that receives the VCO output signal and produces an intermediate signal; and
a divide-by-three frequency translator that receives the intermediate signal and produces the LO signal.

44. A circuit for producing, in a wireless communications device, multiple LO signals from a VCO signal for down-converting a plurality of different RF signals operating in different frequency ranges, the circuit comprising:
a VCO that produces the VCO signal that serves as a first LO signal for down-converting an RF signal of a first type to an IF signal; and
a divide-by-1.5 frequency translator that receives the VCO signal and produces a second LO signal for down-converting a GPS RF signal operating at about 1575 MHz.

45. The circuit of claim 44, wherein the RF signal of the first type is a PCS signal operating within a range of about 1930 to 1990 MHz.

46. The circuit of claim 45, wherein the RF signal of the first type is an IMT2000 signal operating within a range of about 2111 to 2159 MHz.

47. The circuit of claim 44, wherein the RF signal of a first type and the GPS signal are down-converted to a common IF signal frequency.

48. The circuit of claim 47, wherein the common IF signal frequency is about 180 MHz.
